(19) United States
(12) Patent Application Publication
(10) Pub. No.: US 2004/0077206 A1
(43) Pub. Date: Apr. 22, 2004

(54) Method of preventing arcing and component damage in intermediate and high voltage connectors

(76) Inventors: Andrew R. Dixon, Warren, MI (US); James J. Colla JR., Macomb Township, MI (US); Charles McQuillan, Highland, MI (US)

Correspondence Address: CHRISTOPHER DEVRIES, General Motors Corporation, Legal Staff, Mail Code 482-C23-B21, P.O. Box 300, Detroit, MI, 48265-3000, US

(21) Appl. No.: 10/273,204

(22) Filed: Oct. 17, 2002

(51) Int. Cl. H01R 13/62

(52) U.S. Cl. 439/350

(57) ABSTRACT

An electrical connector system prevents arcing and component damage. A primary connector is connected to a primary receptacle on an electrical device. A locking mechanism is integrated with the primary connector. The locking mechanism has a first position that prevents removal of the primary connector from the primary receptacle and a second position that allows the primary connector to be removed from the primary receptacle. A secondary connector is connected to a secondary receptacle on the electrical device. When the secondary connector is connected to its secondary receptacle, the secondary connector prevents movement of the locking mechanism from the first position to the second position. When the secondary connector is disconnected from the secondary receptacle, the locking mechanism is capable of moving into the second position to allow the primary connector to be removed.

### FIELD OF THE INVENTION

The present invention relates to electrical connectors and more particularly to an electrical connector system and method of installing electrical connectors to prevent arcing or component damage.

### BACKGROUND OF THE INVENTION

Electrical devices often receive electrical power from a separate unit, such as a power supply. Typically, power is provided to the electrical device through a removable connector. During the course of operating or testing the electrical device, a user may need to remove an electrical connector from the device.

If the electrical device is operating and drawing current from the power supply, removal of the connector can cause electrical arcing, which may damage the device. Additionally, the device may be damaged simply by removing the electrical connector while the device is running. Ideally, the power supply should be switched off before removing the electrical connector.

There are several conventional approaches for ensuring that a connector is not removed until the electrical device is in a desired state. One approach is to provide a separate disconnect circuit within the connector. The disconnect circuit is connected to the device with a shorter contact pin. If a user attempts to disconnect the connector while the device is running, the shorter contact pin will break a connection to the device first and terminate power to selected components within the device. However, this approach does not prevent damage to the device resulting from an abrupt termination of power during operation. Additionally, if the connector is removed quickly, a high-current arc may still occur.

An alternate approach is to incorporate a solenoid with the connector that mechanically locks the connector into position. The lock is active until power to the connector and the solenoid is terminated. However, this approach requires an additional circuit to be added to power the solenoid. Additionally, the solenoid and mechanical locking mechanism add cost, mass, and size to the electrical connector.

### SUMMARY OF THE INVENTION

An electrical connector system according to the present invention prevents arcing and component damage. A primary connector is connected to a primary receptacle of an electrical device. A locking mechanism is integrated with the primary connector. The locking mechanism has a first position that prevents removal of the primary connector from the primary receptacle and a second position that allows the primary connector to be removed from the primary receptacle. A secondary connector is connected to a secondary receptacle of the electrical device. When the secondary connector is connected to the secondary receptacle, the secondary connector prevents movement of the locking mechanism from the first position to the second position. When the secondary connector is disconnected from the secondary receptacle, the locking mechanism is capable of moving into the second position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an electrical connector arrangement including a primary connector, a secondary connector, and a locking mechanism that is shown in a closed position;

FIG. 2 illustrates the locking mechanism in the closed position, which prevents removal of the primary connector; and

FIG. 3 illustrates the locking mechanism in an open position, which allows disconnection of the primary connector.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity, the same reference numbers will be used in the drawings to identify similar elements.

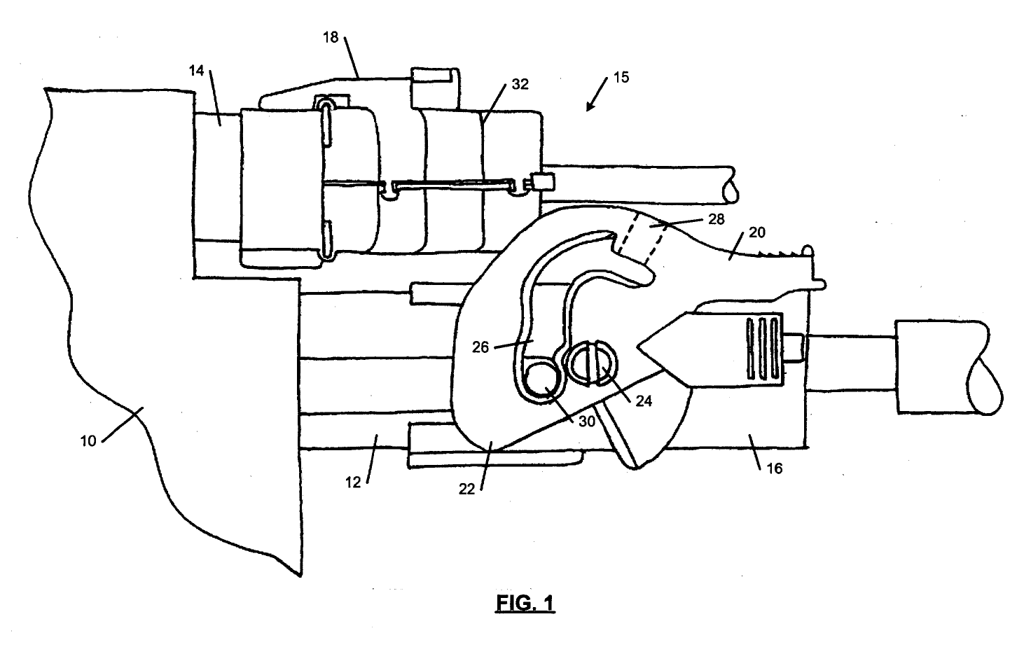

Referring now to FIG. 1, an electrical device 10 includes a primary receptacle 12 and a secondary receptacle 14. An electrical connector 15 includes a primary connector 16 and a secondary connector 18. The primary receptacle 12 receives the primary connector 16. Likewise, the secondary receptacle 14 receives the secondary connector 18. The primary connector 16 and the secondary connector 18 provide power from a power source (not shown) to the electrical device 10. The power provided through the secondary connector 18 to the electrical device is preferably less than the power provided through the primary connector 16.

The primary connector 16 includes a locking mechanism 20. The locking mechanism 20 includes a cam plate 22 that rotates between a closed position and an open position on an axis 24. The cam plate 22 is positioned in the closed position in FIG. 1. Additionally, the cam plate 22 includes a cam groove 26 and a pin slot 28.

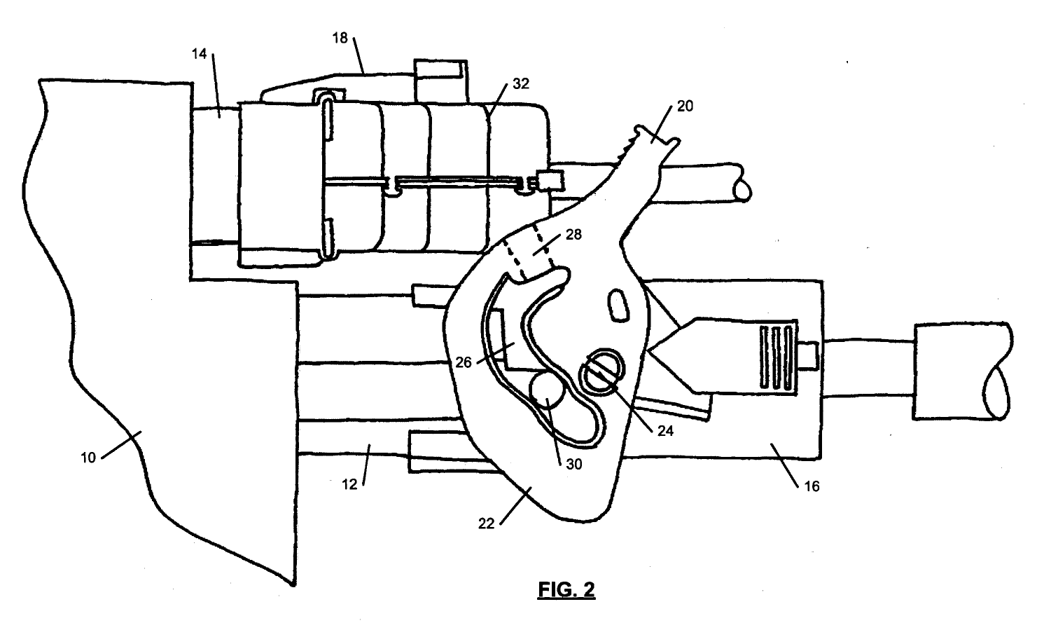

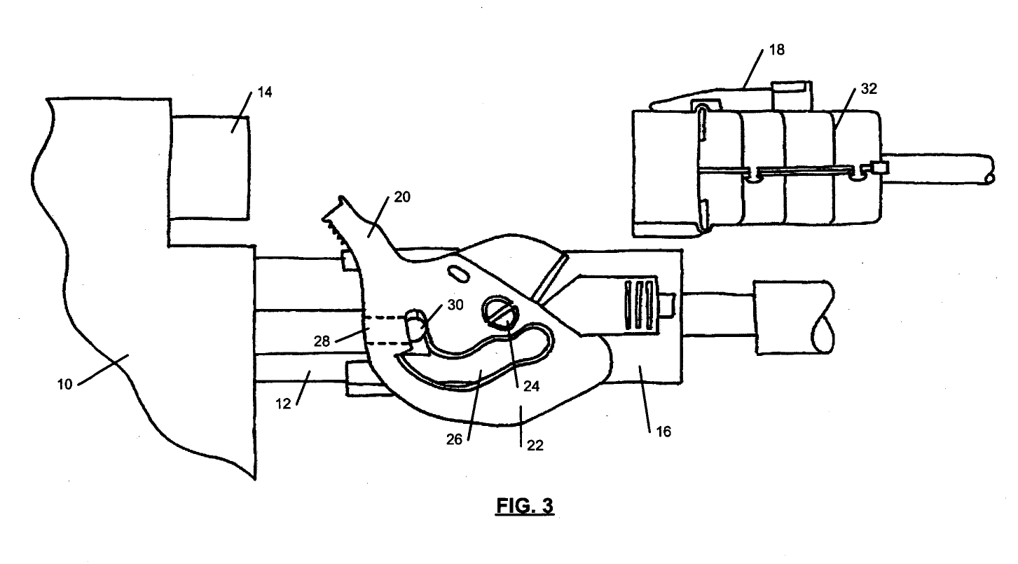

Referring now to FIGS. 2 and 3, a header pin 30 is located on the primary receptacle 12. The pin slot 28 slidably receives the header pin 30. The cam plate 22 is positioned in the open position in FIG. 3. When the cam plate 22 is in the open position, the primary connector 16 can be connected to or disconnected from the primary receptacle 12. When the primary connector 16 is fully connected to the primary receptacle 12, the cam plate 22 is capable of rotating into the closed position to capture the header pin 30 within the cam groove 26. To disconnect the primary connector 16, the cam plate 22 is rotated into the open position to allow the cam groove 26 to release the header pin 30 through the pin slot 28.

The locking mechanism 20, however, does not prevent a user from removing the primary connector 16 when the electrical device 10 is still drawing power. The secondary connector 18 preferably acts as a disconnect circuit for the electrical device 10. When the secondary connector 18 is removed from the secondary receptacle 14, the electrical device 10 no longer draws power through the primary connector 16. Because the secondary connector 18 provides relatively low power to the electrical device 10, a high-current arc between the secondary receptacle 14 and the secondary connector 18 is much less likely to occur. In contrast, the electrical device 10 draws higher power through the primary connector 16.

To ensure that the secondary connector 18 is disconnected from the electrical device 10 before the primary connector 16, the connectors and receptacles are physically arranged so that the secondary connector 18 must be removed first. Referring now to FIGS. 1 through 3, the secondary receptacle 14 is arranged on the electrical device 10 in close proximity to the primary receptacle 12. Consequently, when connected to the secondary receptacle 14, the secondary connector 18 is in close proximity to the primary connector 16. The locking mechanism 20 prevents the primary connector 16 from being disconnected unless the cam plate 22 can be fully rotated from the closed position to the open position. The presence of the secondary connector prevents the cam plate 22 from fully rotating into the open position. As shown in FIG. 2, the cam plate 22 can only achieve partial rotation. The cam plate 22 makes contact with the shoulder 32 of the secondary connector 18, which prevents further rotational movement.

Referring now to FIG. 3, the secondary connector 18 has been removed from the electrical device 10, which causes the electrical device 10 to cease drawing current through the primary connector 16. With the secondary connector 18 removed, the locking mechanism 20 can rotate fully, which allows the cam plate 22 to rotate fully into the open position. In the open position, the pin slot 28 is aligned with the header pin 30. The primary connector 16 can be removed safely from the primary receptacle 12 without any risk of damage to the electrical device 10.

In other embodiments, the electrical device 10 includes a plurality of secondary connectors 18. All of the secondary connectors 18 must be removed before the locking mechanism 20 can rotate fully into the open position. Alternatively, the electrical device 10 includes a plurality of secondary connectors 18 and a plurality of primary connectors 16. Each secondary connector 18 must be removed before the locking mechanism 20 on the corresponding primary connector 16 can rotate fully into the open position.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

1. An electrical connector system for an electrical device, comprising:
a primary connector for a primary receptacle;
a locking mechanism that is integrated with said primary connector and that has a first position and a second position, wherein said first position prevents removal of said primary connector from said primary receptacle, and said second position allows removal of said primary connector from said primary receptacle; and
a secondary connector for a secondary receptacle, wherein said secondary connector prevents movement of said locking mechanism to said second position when said secondary connector is connected to said secondary receptacle, and wherein said locking mechanism is capable of moving into said second position when said secondary connector is disconnected from said secondary receptacle.

2. The electrical connector system of claim 1 wherein voltage is supplied through said primary connector and said secondary connector to said electrical device.

3. The electrical connector system of claim 2 wherein a first voltage provided through said primary connector is greater than a second voltage provided through said secondary connector.

4. The electrical connector system of claim 1 wherein said secondary connector is a disconnect circuit for said electrical device, and wherein said disconnect circuit terminates operation of an electrical component in said electrical device when said secondary connector is removed from said secondary receptacle.

5. The electrical connector system of claim 1 further comprising a plurality of secondary connectors for a plurality of secondary receptacles, wherein said plurality of secondary connectors prevents said locking mechanism from attaining said second position, and removal of said plurality of secondary connectors from said plurality of secondary receptacles allows said locking mechanism to attain said second position.

6. The electrical connector system of claim 1 wherein current is provided through said secondary connector to an electric motor within an electrical device, and wherein said electrical device draws current through said primary connector when said electric motor is running.

7. A method for regulating the removal of an electrical connector from an electrical device, comprising:
providing a primary connector for a primary receptacle;
integrating a locking mechanism with said primary connector;
preventing removal of said primary connector from said primary receptacle when said locking mechanism is in a first position;
allowing removal of said primary connector from said primary receptacle when said locking mechanism is in a second position;
providing a secondary connector for a secondary receptacle; and
preventing movement of said locking mechanism between said first and second positions when said secondary connector is inserted in said secondary receptacle.

8. The method of claim 7 further comprising:
supplying a first voltage through said primary receptacle and said primary connector to said electrical device; and
supplying a second voltage through said secondary receptacle and said secondary connector to said electrical device.

9. The method of claim 8 wherein said first voltage is greater than said second voltage.

10. The method of claim 7 wherein said secondary connector is a disconnect circuit that terminates operation of an electrical component within said electrical device when said secondary connector is removed from said secondary receptacle.

11. The method of claim 8 further comprising:
removing said secondary connector from said secondary receptacle to discontinue said electrical voltage to said secondary receptacle; and
removing said primary connector from said primary receptacle.
